(19) United States
(12) Patent Application Publication
(10) Pub. No.: US 2010/0184373 A1
(43) Pub. Date: Jul. 22, 2010

(54) INFORMATION TERMINAL DEVICE

(75) Inventors: Hiroyuki HEBIGUCHI, Miyagi-ken (JP); Makoto SASAKI, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/750,614

(22) Filed: Mar. 30, 2010

Related U.S. Application Data
(63) Continuation of application No. PCT/JP2008/068433, filed on Oct. 10, 2008.

(30) Foreign Application Priority Data
Oct. 11, 2007 (JP) 2007-265408

(51) Int. Cl. H04B 5/00

(52) U.S. Cl. 455/41.1

(57) ABSTRACT

A mobile phone includes a display unit for visually confirming the information and an input unit for inputting the information. The display unit includes a display element, and the input unit includes an operation button. The mobile phone contains an electrode pair formed of a human side electrode and an external electrode for human body communication inside the casing. The mobile phone has the external electrode disposed around the display unit, and the human side electrode disposed around the input unit.

### CLAIM OF PRIORITY

This application is a continuation of International Application No. PCT/JP2008/068433 filed on Oct. 10, 2008, which claims benefit of the Japanese Patent Application No. 2007-265408 filed on Oct. 11, 2007, both of which are hereby incorporated by reference.

### BACKGROUND OF THE INVENTION

1. Field of the Invention

The present invention relates to an information terminal device to which human body communication is applied.

2. Description of the Related Art

The communication method using the electric field induced by the human body has been proposed as a totally new communication method accompanied with the recent technological advancement. Japanese Unexamined Patent Application Publication (Translation of PCT Application) No. 11-509380 discloses the aforementioned communication system which applies the electric field corresponding to the modulation signal obtained by modulating the information signal to a human body as a transmission medium from the transmitter, and detects the electric field which has transmitted the human body using the receiver so as to demodulate the signal corresponding to the electric field.

In the aforementioned communication system, each of the transmitter and the receiver includes an electrode pair 51 formed of a human side (inner) electrode 51a densely capacitively coupled with a human body 52, and an external (outer) electrode 51b oriented to be coupled with a room earth 53 denser than the human side (inner) electrode 51a, respectively as illustrated in FIG. 5. The pair is formed as a parallel flat plate.

Referring to FIG. 5, in the structure provided with the pair of the human side electrode 51a and the external electrode 51b which forms the parallel flat plate electrode as disclosed in Japanese Unexamined Patent Application Publication (Translation of PCT Application) No. 11-509380, the capacitance coupling between the human side electrode and the external electrode is high. Accordingly, the capacity loss caused by charging/discharging becomes too large to achieve sufficient communication quality. If the electrode area is increased for improving the communication quality, the capacitance coupling between the human side electrode and the external electrode to form the parallel flat plate electrode becomes high. This may deteriorate the transmission efficiency, thus failing to improve the receiving sensitivity.

In the case where the electrode for transmitter/receiver exclusively for the human body communication is newly added for communication, the electrode for transmitter/receiver will largely extend from the information terminal device. Accordingly, the rotatable or slidable linking mechanism has to be further added to retract the electrode for transmitter/receiver in the unused state. In such a case, the thickness of the device is increased, which inevitably influences the design, and increases the cost and weight as well.

### SUMMARY OF THE INVENTION

The present invention provides an information terminal device capable of improving communication quality while reducing the loss by decreasing the coupling capacitance between the human side electrode and the external electrode without essentially changing design of the information terminal device.

The present invention provides an information terminal device with an electrode pair formed of a human side electrode and an external electrode for a human body communication. The information terminal device includes a display unit with a display element for visually confirming information and an input unit with an input element for inputting the information. The external electrode is disposed in the display unit, and the human side electrode is disposed in the input unit. The external electrode serves as an electrode contained in the display element.

The aforementioned structure decreases the coupling capacitance between the human side electrode and the external electrode to reduce the loss, thus improving communication quality. The use of the structure for the transmitter allows improvement of the transmission efficiency so as to prolong the battery life by reducing the power consumption of the transmitter while keeping the communication quality at the same level. The external electrode area may be enlarged without adding the part or changing design of the information terminal device to improve both design and communication quality. As the human side electrode is disposed in the input unit rather than the display unit, the coupling capacitance between the external electrode and the human side electrode is not increased in spite of the enlarged external electrode, thus ensuring the improved communication quality. The aforementioned structure suppresses increase in the cost and weight without requiring additional electrode exclusive for human body communication.

Preferably, the human side electrode is disposed in at least one of an operation surface and a side surface of the input unit.

The present invention provides an information terminal device with an electrode pair formed of a human side electrode and an external electrode for a human body communication. The information terminal device includes a display unit with a display element for visually confirming information and an input unit with an input element for inputting the information. The external electrode is disposed in the display unit, and the human side electrode is disposed in the input unit. The human side electrode serves as an electrode contained in the input element. The device is structured to allow the human body (finger) to be pressed against the input element under pressure upon input operation to reliably reinforce the capacitance coupling between the human body and the human side electrode. This makes it possible to improve communication quality by ensuring the capacitance coupling between the human side electrode and the human body without changing the design while preventing increase in cost and weight.

Preferably, the external electrode is disposed in at least one of a display surface, a back surface and a side surface of the display unit.

The information terminal device according to the present invention is provided with an electrode pair formed of a human side electrode and an external electrode for human body communication, and further includes a display unit with a display element for visually confirming the information, and an input unit with an input element for inputting the information. The external electrode is disposed in the display unit, and the human side electrode is disposed in the input unit so as to improve the communication quality while reducing the loss by decreasing the coupling capacitance between the human side electrode and the external electrode without essentially changing design of the information terminal device.

### BRIEF DESCRIPTION OF THE DRAWINGS

FIGS. 1A and 1B are perspective views each illustrating a mobile phone as an information terminal device according to an embodiment of the present invention, wherein FIG. 1A illustrates the mobile phone of straight type, and FIG. 1B illustrates the mobile phone of folding type;

FIG. 2 is an exploded perspective view illustrating the structure of a liquid crystal display element as a display element of the mobile phone 1 illustrated in FIG. 1;

FIG. 3 is a sectional view of the structure of an operation button as an input element of the mobile phone 1 illustrated in FIG. 1;

FIG. 4 is a perspective view of a laptop computer as the information terminal device according to another embodiment of the present invention; and

FIG. 5 is a view for explaining the human body communication.

### DESCRIPTION OF THE PREFERRED EMBODIMENTS

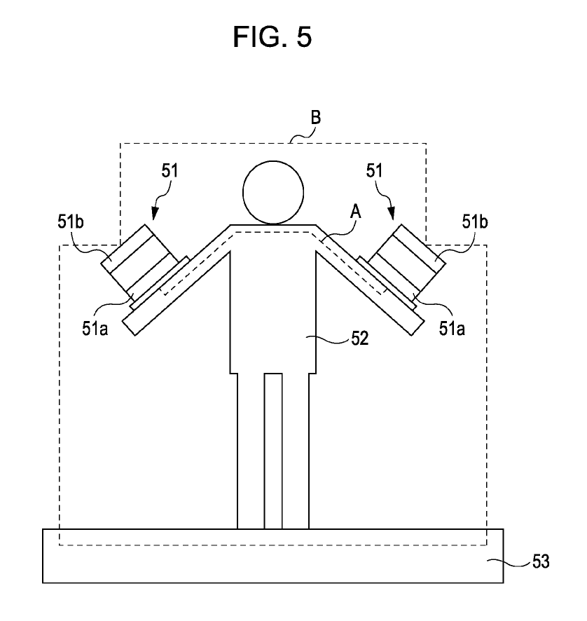

The human body communication using the electric field requires a forward path (path A shown in FIG. 5) through which the signal flows via the capacitance coupling among the transmitter, the human body, and the receiver, and a return path (path B shown in FIG. 5) through which the signal flows via the capacitance coupling between the receiver and derivative such as air, or between the conductor such as earth and the receiver. Preferably, the human side electrode 51a (transmitter and receiver sides) for constituting the forward path intensifies the capacitance coupling with respect to the human body 52, and the capacitance coupling with the human side electrode 51a (transmitter and receiver sides) via the human body 52. Preferably, the capacitance coupling between the external electrode 51b (transmitter and receiver sides) for constituting the forward path is reduced, and the capacitance coupling with the external electrode 51b (transmitter and receiver sides) is intensified. This makes it possible to efficiently transmit the signal. The capacitance coupling between the human side electrode 51a and the external electrode 51b is reduced for efficient transmission by decreasing the signal loss.

The inventors focus the capacitance coupling state between the above-described electrodes in the human body communication. Then arrangements of the human side electrode and the external electrode are specified in consideration that the information terminal device has the display unit and the input unit separately formed, especially the structure of the information terminal device which can be opened and closed, for example, the laptop personal computer, the folding type mobile phone and the like. It is found that the use of the aforementioned structure improves communication quality without essentially changing the design.

The information terminal device according to the present invention is provided with an electrode pair formed of a human side electrode and an external electrode for the human body communication, and further includes a display unit for visually confirming the information, and the input unit for inputting the information. In the information terminal device, the external electrode is disposed in the display unit, and the human side electrode is disposed in the input unit so as to improve communication quality while decreasing the loss by reducing the coupling capacitance between the human side electrode and the external electrode.

Embodiments of the present invention will be described in detail referring to the drawings.

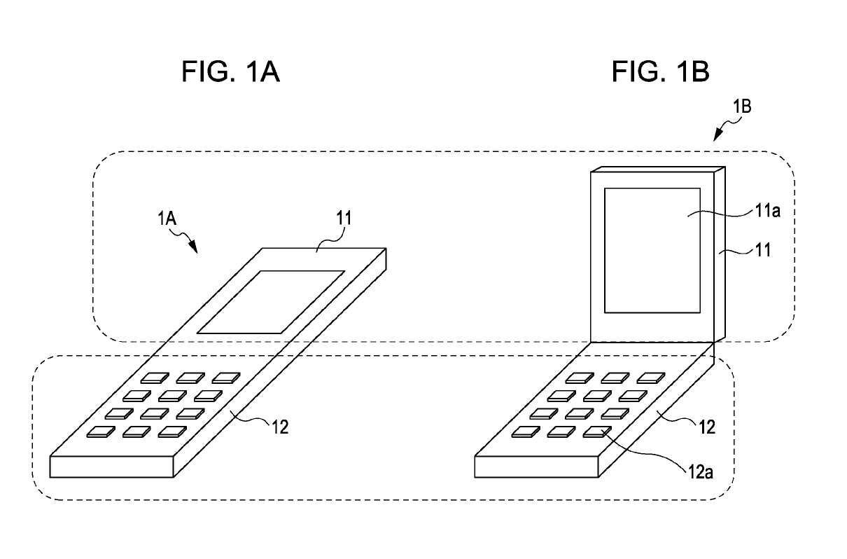

FIGS. 1A and 1B are perspective views each illustrating a mobile phone as an information terminal device according to an embodiment of the present invention. FIG. 1A illustrates a straight type mobile phone, and FIG. 1B illustrates a folding type mobile phone.

Each of the mobile phones 1A and 1B shown in FIGS. 1A and 1B includes a display unit 11 for visually confirming the information and an input unit 12 for inputting the information. The display unit 11 includes a display element 11 a formed of an LCD (liquid crystal display element), an EL (electroluminescence) element and the like. The input unit 12 includes an operation button 12a.

Each of the mobile phones 1A and 1B includes an electrode pair inside casing, which is formed of a human side electrode and an external electrode for the human body communication. The display unit 11 and the input unit 12 may be disposed at the upper and lower positions of the bar-like casing likewise the mobile phone 1A. Likewise the mobile phone 1B, they may be disposed in the casing which may be opened/closed or folded. Alternatively, the display unit 11 may be produced separately from the input unit 12 so as to be joined together.

In the mobile phone 1, the external electrode is installed in the display unit 11. The external electrode may be disposed in the casing surface, back surface, side surface and/or inside of the display unit 11. If the external electrode is disposed inside the casing which contains the display unit 11, a portion of the respective circuit substrates in the display unit 11 may be formed as the external electrode. That is, the external electrode may be structured to serve as the electrode contained in the display element for forming the display unit 11. The external electrode may serve as the ground layer in the circuit substrate such as the driving circuit of the display element and the respective communication circuits.

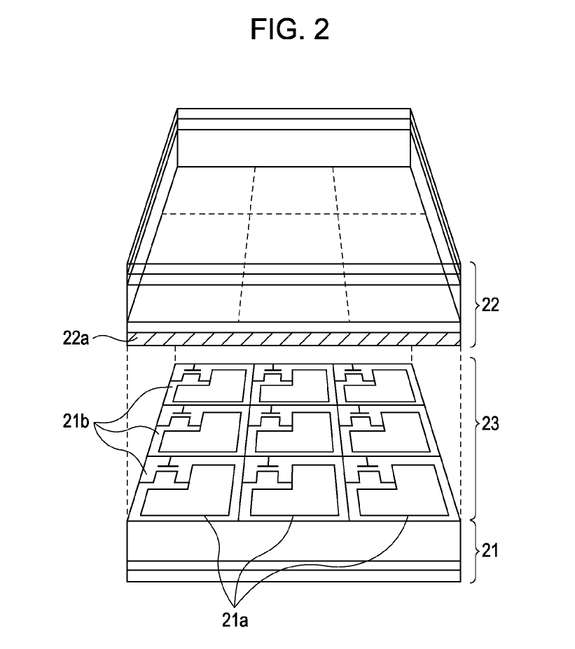

FIG. 2 is an exploded perspective view illustrating the structure of the liquid crystal element as the display element 11a of each of the mobile phones 1A and 1B illustrated in FIGS. 1A and 1B. The liquid crystal display element shown in FIG. 2 is an active matrix type liquid crystal display element which is formed of an array substrate 21 including pixel electrodes 21a and TFTs (thin film transistor) 21b, an opposite substrate 22 with a common electrode 22a, and a liquid crystal layer 23 between the array substrate 21 and the opposite substrate 22.

Among the aforementioned elements, the common electrode 22a as the single electrode to cover the entire screen is especially suitable for the common use as the external electrode. The common electrode 22a with a large area and very small potential fluctuation is suitable for the use as the external electrode. The bus electrode provided over the entire screen may be used as the external electrode. A transparent conductive film is applied on the upper surface of the opposite substrate (opposite the common electrode side) so as to be used as the external electrode.

The display element which occupies the large area of the information terminal device may be used as the external electrode to keep the large area without newly adding the part or changing design of the information terminal device. This makes it possible to improve both the design and communication quality. As the human side electrode is disposed in the input unit 12 rather than the display unit 11, the increase in the area of the external electrode may not intensify the coupling capacitance with the human side electrode, thus reliably improving the communication quality. The aforementioned structure is capable of suppressing the cost or the weight without requiring addition of the electrode exclusively for the human body communication.

The frequency of the image signal for displaying the information is determined depending on the number of display pixel and the frame rate. However, it is generally set to several MHz or higher. The human body communication allows selection of the frequency different from the generally set frequency, thus preventing interference between the image signal and the human body communication signal in spite of the common use of the electrode. The respective signals may be separated by taking only the required signal through the band pass filter.

In each of the mobile phones 1A and 1B, the human side electrode is disposed in the input unit 12 at the region accessible by the user's hand, for example, the casing surface, back surface, side surface and/or inside of the input unit 12. The human side electrode may be disposed at an appropriate position depending on the intended use such as the left/right side surface and the edge line thereof, and the front corner of the mobile phone 1.

Except the voice input, in most of the case, the generally employed input element is likely to be manually operated, for example, keyboard, joystick, track ball, touch panel, mouse, game pad, arrow key, various types of switches and volumes, fingerprint sensor and the like. In the present invention, preferably, the human side electrode is disposed in the aforementioned portions accessible by the user's hand. In case of the joystick, metal is used as the core member so as to serve as the human side electrode. In case of the arrow key or various types of the switch, the human side electrode may be formed around the portion accessible by the user's finger or the electrode for the switch is extended so as to be commonly used as the human side electrode.

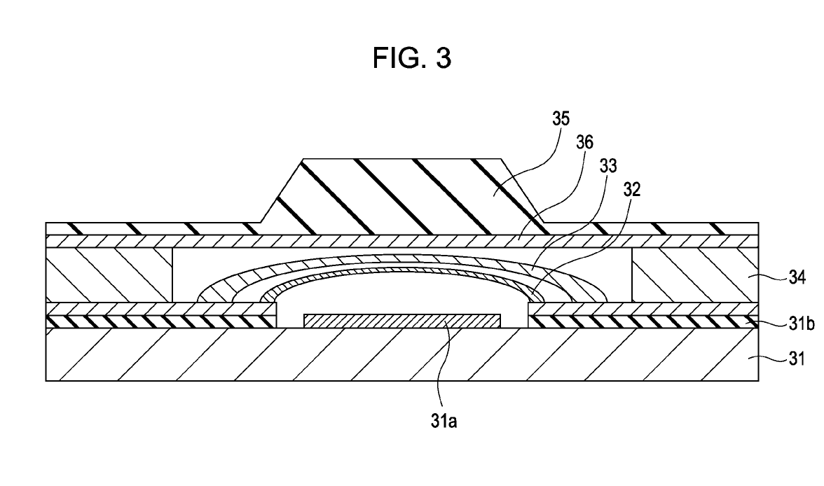

The human side electrode may be disposed inside the input unit 12 as shown in FIG. 3. FIG. 3 is a sectional view of a structure of the operation button 12a as the input element of each of the mobile phones 1A and 1B shown in FIGS. 1A and 1B. The operation button shown in FIG. 3 is so called a metal dome sheet switch which is mainly formed of a substrate 31 with a wiring pattern 31a, a metal dome 32 disposed on the wiring pattern 31a via an insulating layer 31b, a pressing sheet 33 to cover the metal dome 32, a rubber sheet 35 disposed on the substrate 31 via a spacer 34, and a human side electrode 36 disposed inside the rubber sheet 35. The wiring may be pulled from the metal dome 32 so as to be used as the human side electrode. The human side electrode may serve as the electrode contained in the input element for forming the input unit 12.

In the case where the element having the electrode around the surface such as the touch panel, the LCD, and the electronic paper is formed as the input element, the electrode may be used as the human side electrode. In this case, the frequency for the input signal is made different from the frequency for the human body communication so as to prevent the signal interference.

As the human side electrode is formed in the input unit accessible by the user's hand, or the input element member serves as the human side electrode, the human body (finger) is pressed against the input element upon input operation. This makes it possible to stably reinforce the capacitance coupling between the human body and the human side electrode. The capacitance coupling between the human side electrode and the human body is ensured to improve communication quality. The design does not have to be changed for forming the structure, and there is no increase in the weight. Especially when the electrode as a part of the input element serves as the human side electrode, there is no cost increase.

The external electrode and the human side electrode are separately disposed at different locations of the display unit 11 and the input unit 12, respectively. Unlike the generally employed case where the human side electrode and the external electrode are oppositely arranged to form the parallel flat plate, the coupling capacitance between the external electrode and the human body electrode is largely reduced. The loss caused by the coupling capacitance may be suppressed, thus improving communication quality. The use of the aforementioned structure for the transmitter may improve the transmission efficiency. This makes it possible to prolong the battery life by reducing the power consumption of the transmitter while keeping the communication quality at the same level.

Operations of the above structured information terminal device upon human body communication will be described. When the operation button 12a on the input unit 12 of either the mobile phone 1A or 1B shown in FIGS. 1A and 1B is depressed, the electric field corresponding to the modulation signal obtained by modulating the carrier wave at the specific frequency (several tens kHz to several tens MHz) is applied to the user (human body). There is no specific restriction with respect to the modulation method for the mobile phones 1A and 1B.

The electric field applied to the user is received by the communication electrode of the receiver (not shown). Upon application of the electric field to the communication electrode, the physical quantity (induced electromotive force, induced current) is induced, and detected by the signal detection circuit (not shown). The physical quantity detected by the signal detection circuit is sent to the demodulation circuit (not shown) for demodulation with the carrier wave used in the mobile phone 1 to obtain the information signal. In this way, the communication may be conducted using the human body as the transmission medium. In this case, the information terminal device (mobile phone 1) according to the present invention is used as the transmitter for the human body communication system. However, the information terminal device (mobile phone 1) may be used as the receiver of the human body communication system.

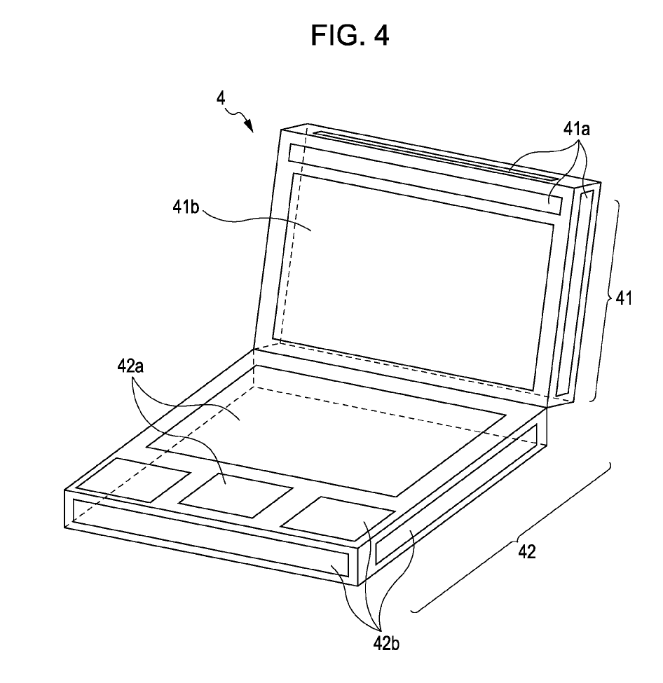

The present invention is applicable to a laptop computer (notebook PC) as the information terminal device. FIG. 4 is a perspective view of the laptop computer as the information terminal device according to the embodiment of the present invention. The notebook PC 4 illustrated in FIG. 4 includes a display unit 41 for visually confirming the information, and an input unit 42 for inputting the information. Those units are connected to be opened and closed. The notebook PC 4 includes a human side electrode 42b and an external electrode 41a for human body communication. The external electrode 41a is disposed around a display element 41b of the display unit 41 (in this case, the upper portion of the same surface as that of the display element 41b, and the side surface of the display unit 41). The human side electrode 42b is disposed around an input element 42a (in this case, on the same surface as the input element 42a and the side surface of the input unit 42).

In the case where each of the display unit 41 and the input unit 42 has substantially a cuboidal shape, the external electrode 41a and the human side electrode 42b may be disposed on the respective surfaces and edge lines of those units. The aforementioned arrangement allows the external electrode 41a and the human side electrode 42b to be provided without changing design of the device. Especially, it is preferable to allow the human side electrode 42b to be in contact with the human body reliably. Such electrode may be disposed at the appropriate position depending on the intended usage state, for example, the front surface and the edge line of the keyboard of the notebook PC 4.

Unlike the generally employed case where the human side electrode and the external electrode are oppositely disposed to form the parallel flat plate, the coupling capacitance between the external electrode and the human side electrode may be largely reduced, thus improving communication quality while suppressing the loss caused by the coupling capacitance.

There is no need of protruding the external electrode 41a and/or the human side electrode 42b from the casing of the display unit 41 and the input unit 42. The display unit 41 and/or the input unit 42 may be disposed inside the casing. In such a case, the human side electrode 42b is disposed on the position around the surface as close as possible to improve communication quality.

Recent sophisticated mobile phone requires ID system through inputting of the password or biometrics such as fingerprint authentication upon payment of electronic money. It is assumed that the card which contains the ID information is carried besides the mobile phone such that the encrypted ID information is transmitted to the mobile phone via the human body for satisfying the aforementioned demand. In this case, the ID information sent from the input element through the human body may be confirmed simultaneously with authentication of the password and fingerprint upon payment. This makes it possible to improve security upon the payment. In the aforementioned case, the human side electrode may be formed in the key through which the password is input or the fingerprint sensor to allow the user to easily operate without being bothered. Especially the use of the fingerprint sensor of electrostatic type is well compatible with the human body communication system of electric field method as the preferred combination, which allows common use of the electrodes. The ID system may be applied to various types of game besides the mobile phone. Besides the ID system, it is preferable to form the human side electrode in the input element for the operation to which the human communication is applied.

The present invention is not limited to the aforementioned embodiments but may be changed into various forms. For example, in the embodiments, the mobile phone or the laptop computer is employed as the information terminal device. However, the present invention is not limited to those devices, but may be applied to various kinds of the device having the display unit and input unit separately disposed, or the other information terminal device which can be opened/closed or folded. In the embodiments as described above, the display element is the liquid crystal display element, and the input element is the metal dome switch. However, the present invention is not limited to those elements but may be applied to the other display element and the input element, which can be modified without departing from the scope of the present invention.

What is claimed is:

1. An information terminal device provided with an electrode pair including a human side electrode and an external electrode for a human body communication, comprising:
a display unit with a display element for visually confirming information; and
an input unit with an input element for inputting the information, wherein:
the external electrode is disposed in the display unit, and the human side electrode is disposed in the input unit; and
the external electrode serves as an electrode contained in the display element.

2. The information terminal device according to claim 1, wherein the human side electrode is disposed in at least one of an operation surface and a side surface of the input unit.

3. An information terminal device provided with an electrode pair including a human side electrode and an external electrode for a human body communication, comprising:
a display unit with a display element for visually confirming information; and
an input unit with an input element for inputting the information, wherein:
the external electrode is disposed in the display unit, and the human side electrode is disposed in the input unit; and
the human side electrode serves as an electrode contained in the input element.

4. The information terminal device according to claim 3, wherein the external electrode is disposed in at least one of a display surface, a back surface and a side surface of the display unit.
